(19) United States
(12) Patent Application Publication
(10) Pub. No.: US 2020/0304340 A1
(43) Pub. Date: Sep. 24, 2020

(54) IN-VEHICLE RELAY DEVICE

(71) Applicant: DENSO CORPORATION, Kariya-city (JP)

(72) Inventor: Shuhei ITODA, Kariya-city (JP)

(21) Appl. No.: 16/896,569

(22) Filed: Jun. 9, 2020

Related U.S. Application Data
(63) Continuation of application No. PCT/JP2018/041572, filed on Nov. 9, 2018.

(30) Foreign Application Priority Data
Dec. 11, 2017 (JP) 2017-236713

(51) Int. Cl. H04L 12/46; H04L 29/08; B60R 16/023

(52) U.S. Cl. CPC H04L 12/4641; B60R 16/0231; H04L 67/12; H04L 69/322

(57) ABSTRACT

An in-vehicle relay device includes a layer 2 relay unit and a layer 3 relay unit. A hardware circuit performs functions of a layer 1 to a layer 3. A microcomputer performs functions of a layer 4 and higher layers than the layer 4.

### CROSS REFERENCE TO RELATED APPLICATIONS

The present application is a continuation application of International Patent Application No. PCT/JP2018/041572 filed on Nov. 9, 2018, which designated the U.S. and claims the benefit of priority from Japanese Patent Application No. 2017-236713 filed on Dec. 11, 2017. The entire disclosures of all of the above applications are incorporated herein by reference.

### TECHNICAL FIELD

The present disclosure relates to an in-vehicle relay device.

### BACKGROUND

A relay device used in an in-vehicle communication network has been proposed. The relay device includes a plurality of ports. When one of the plurality of ports inputs a signal, the signal is transmitted to another one of the plurality of ports connected to the same relay device and designated by a destination included in the signal.

### SUMMARY

The present disclosure provides an in-vehicle relay device that includes a layer 2 relay unit and a layer 3 relay unit. A hardware circuit performs functions of a layer 1 to a layer 3. A microcomputer performs functions of a layer 4 and higher layers than the layer 4.

### BRIEF DESCRIPTION OF DRAWINGS

The features and advantages of the present disclosure will become more apparent from the following detailed description made with reference to the accompanying drawings. In the drawings:

FIG. 1 is a diagram showing a configuration of an in-vehicle communication system;

FIG. 2 is a block diagram showing a configuration of a relay device; and

FIG. 3 is a block diagram showing a configuration of a relay device.

### DETAILED DESCRIPTION

For example, in an in-vehicle ECU having a relay function, each of a physical layer and a data link layer in OSI reference model is provided by an

ASIC, and layers higher than the data link layer are provided by a microcomputer. Therefore, when the relay function is executed in a network layer which is the layer 3, the microcomputer executes the relay function by software.

However, the relay at the network layer requires a relay across the network, and thus has a high processing load. As a result, communication delay may occur even when a high-performance microcomputer is used. Further, since the processing load is high, heat generation may increase.

The present disclosure to provide an in-vehicle relay device that is less likely to cause a communication delay and can also reduce heat generation.

An exemplary embodiment of the present disclosure provides an in-vehicle relay device that includes a layer 2 relay unit and a layer 3 relay unit. A hardware circuit performs functions of a layer 1 to a layer 3. A microcomputer performs functions of a layer 4 and higher layers than the layer 4.

In the exemplary embodiment of the present disclosure, the hardware circuit performs the functions of the layer 1 to the layer 3, and thus the layer 3 relay unit is provided by a hardware circuit. The processing speed is increased by providing the layer 3 relay unit as a hardware circuit. Therefore, communication delay is less likely caused. In addition, heat generation can be reduced by using the hardware circuit. Furthermore, since the microcomputer executes the processing of the layer 4 and above, it is possible to use the microcomputer that is not so sophisticated in function.

(Embodiment)

(Entire Configuration)

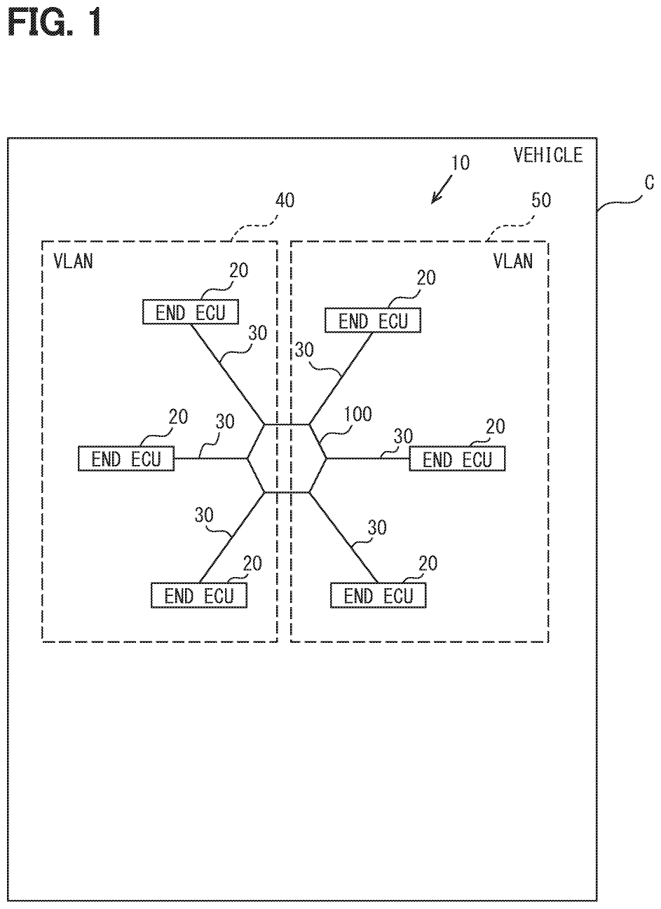

Hereinafter, embodiments will be described with reference to the drawings. FIG. 1 shows an exemplary configuration of an in-vehicle communication system 10. The in-vehicle communication system 10 is configured according to the in-vehicle Ethernet standard. “Ethernet” is a registered trademark. The in-vehicle communication system 10 is mounted on a vehicle C.

The in-vehicle communication system 10 shown in FIG. 1 includes six end ECUs 20 and one relay device 100. The number of the end ECUs 20 is an example, and any number of the end ECUs 20 can be provided.

The end ECU 20 corresponds to a node connected to the relay device 100 via a cable 30. The node may be a sensor or the like instead of the ECU. Alternatively, another relay device may be connected as a node. Each end ECU 20 directly communicates only with the relay device 100. When transmitting a signal to another node, the end ECU 20 causes the signal to include an address of the destination node. This signal is output to the relay device 100 via the cable 30. The cable 30 may be a twisted pair cable.

The relay device 100 divides a plurality of nodes connected to the relay device 100 into two VLANs (Virtual LANs) 40, 50. It should be noted that the number of VLANs is an example, and the plurality of nodes may be divided into three or more VLANs 40, 50. The relay device corresponds to an in-vehicle relay device.

(Configuration of Relay Device 100)

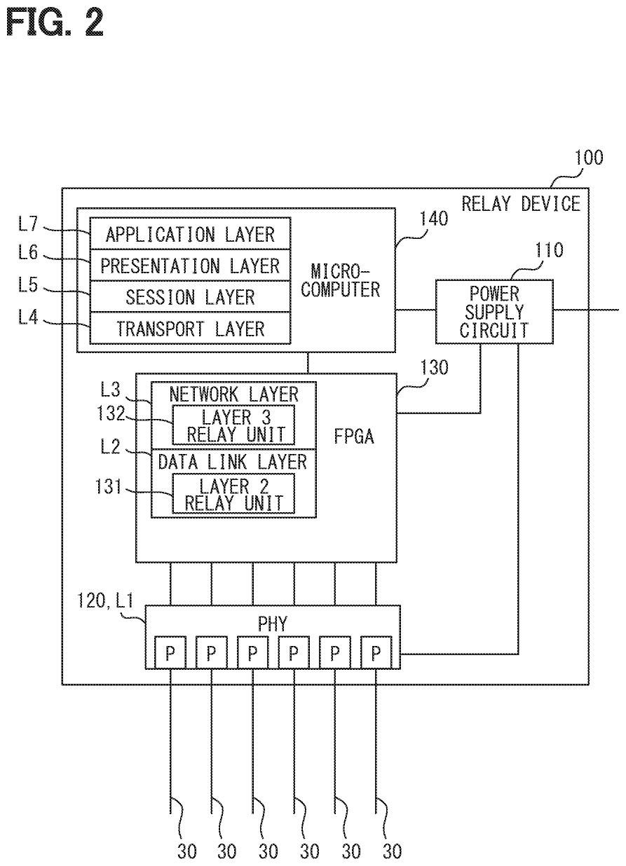

The configuration of the relay device 100 is shown in FIG. 2. The relay device 100 includes a power supply circuit 110, a PHY 120, an FPGA (field-programmable gate array) 130, and a microcomputer 140.

The power supply circuit 110 supplies power to the PHY 120, the FPGA 130, and the microcomputer 140.

The PHY 120 includes a plurality of ports P. In FIG. 1, six ports P1, P2,

P3, P4, P5, P6 are provided. When each of the six ports P1, P2, P3, P4, P5, P6 is not distinguished, it is described as a port P.

One end of the cable 30 is connected to the port P. The other end of the cable 30 is connected to the end ECU 20.

The PHY 120 converts the signal supplied from the FPGA 130 into an electric signal capable of being transmitted to the cable 30.The PHY 120 also converts the signal supplied from the end ECU 20 via the cable 30 into a signal capable of being processed by the FPGA 130. The PHY 120 corresponds to a physical layer in the OSI reference model, that is, a layer 1 L1. In addition to the above-described signal conversion, the PHY 120 also performs frame coding, serial/parallel conversion, signal waveform conversion, and the like. The PHY 120 is provided by an IC including an analog circuit, that is, a hardware circuit. In FIG. 2, one PHY 120 includes a plurality of ports P. Alternatively, the PHY 120 may be divided into a plurality of PHYs such as an independent configuration for each port P.

The FPGA 130 is programmed to execute the functions of a layer 2 L2 and a layer 3 L3 in the OSI reference model.

The layer 2 L2 is a data link layer and performs communication in the same VLAN 40, 50. The layer 2 L2 also detects an error of the signal. The layer 2 L2 functions as a layer 2 relay unit 131. The layer 2 relay unit is also referred to as a layer 2 relay. The layer 2 relay unit 131 performs communication in the same VLAN 40, 50. The layer 2 relay unit 131 determines the node to which the signal is to be transmitted based on a MAC (Media Access Control) address.

The layer 3 L3 is a network layer and performs communication between different networks. In order to perform communication between networks, the layer 3 L3 functions as a layer 3 relay unit 132. The layer 3 relay unit is also referred to as a layer 3 relay. The layer 3 relay unit 132 performs communication in the different VLAN 40, 50. The layer 3 relay unit 132 determines the node to which the signal is to be transmitted based on an IP (Internet Protocol) address.

The microcomputer 140 is a computer including a CPU, a ROM, a RAM, an I/O, and a bus line for connecting these components. The ROM stores a program for causing a general-purpose computer to function as the microcomputer 140. The microcomputer 140 functions as a layer 4 L4, a layer 5 L5, a layer 6 L6, and a layer 7 L7 by executing the program stored in the ROM while using the temporary storage function of the RAM. That is, the layer 4 L4, the layer 5 L5, the layer 6 L6, and the layer 7 L7 are realized by the software processing. It should be noted that a storage medium for storing the program executed by the CPU is not limited to the ROM. The program may be stored in a non-transitory tangible storage medium.

The layer 4 L4 is a transport layer and executes inter-program communication, data transfer guarantee, and the like. The layer 5 L5 is a session layer, the layer 6 L6 is a presentation layer, and the layer 7 L7 is an application layer. The layer 5 L5, the layer 6 L6, and the layer 7 L7 execute user authentication, data encoding and decoding, a user interface function, and the like. The relay device 100 having these functions can also be referred to as a switching hub ECU. The functions of the layer 2 relay unit 131 and the layer 3 relay unit 132 may be referred to as a switch.

(Summary of Embodiment)

In the relay device 100 of the present embodiment, the layer 2 L2 and the layer 3 L3 are provided by the FPGA 130 that is a hardware circuit, so the layer 3 relay unit 132 is provided by the hardware circuit. The processing speed is increased by providing the layer 3 relay unit 132 as the hardware circuit. Therefore, communication delay is less likely caused. In addition, heat generation can be reduced by using the hardware circuit.

Furthermore, since the microcomputer 140 executes the processing of the layer 4 L4 and above, it is possible to use the microcomputer 140 that is not so sophisticated in function.

Although the embodiments of the present disclosure have been described above, the present disclosure is not limited to the above embodiments, and various modified examples described below are also included in the technical scope of the present disclosure. Furthermore, various modifications other than the following can be made without departing from the gist. In the following description, elements having the same reference numerals as those used so far are the same as elements having the same reference numerals in the previous embodiments, except when specifically mentioned. When only a part of the configuration is described, the embodiment described above can be applied to other parts of the configuration.

(First Modification)

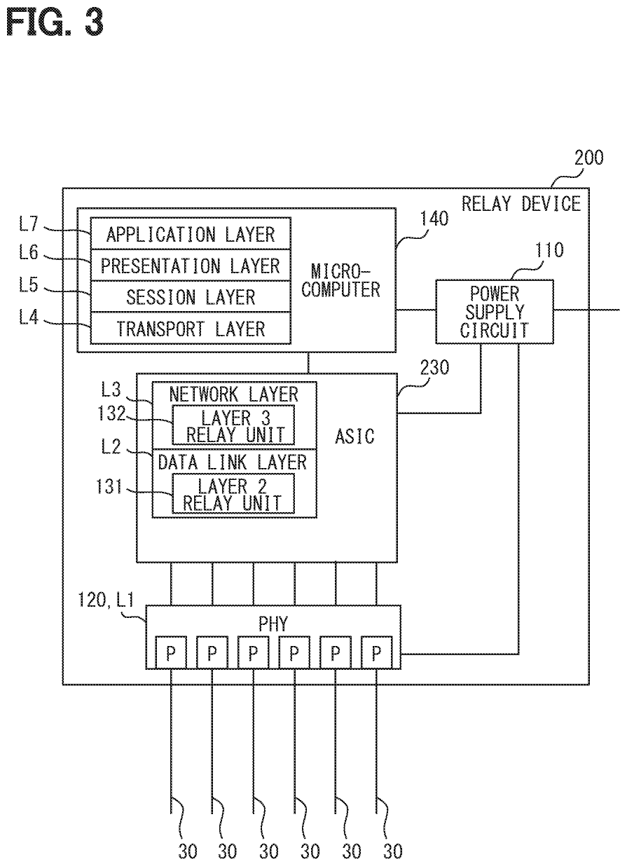

In the relay device 100 of the embodiment, the layer 2 L2 and the layer 3 L3 are provided by the FPGA 130. However, as shown in FIG. 3, a relay device 200 including an ASIC 230 instead of the FPGA 130 may be employed.

(Second Modification)

The PHY 120 may not be necessarily provided separately from the FPGA 130 or the ASIC 230, and the FPGA 130 or the ASIC 230 may function as the PHY 120.

(Third Modification)

A hardware circuit having the functions of the layer 1 L1 and the layer 2 L2 and a hardware circuit having the function of the layer 3 L3 may be separated.

What is claimed is:

1. An in-vehicle relay device comprising:
a layer 2 relay unit; and
a layer 3 relay unit, wherein:
a hardware circuit performs functions of a layer 1 to a layer 3; and
a microcomputer performs functions of a layer 4 and higher layers than the layer 4.

2. The in-vehicle relay device according to claim 1, wherein
the hardware circuit that performs the function of the layer 3 is provided by an FPGA.

3. The in-vehicle relay device according to claim 2, further comprising
the FPGA configured to perform the functions of the layer 1 to the layer 3.

4. The in-vehicle relay device according to claim 1, wherein
the hardware circuit that performs the function of the layer 3 is provided by an ASIC.

5. The in-vehicle relay device according to claim 4, further comprising
the ASIC configured to perform the functions of the layer 1 to the layer 3.

6. The in-vehicle relay device according to claim 1, wherein
the in-vehicle relay device is configured by an OSI reference model.

7. The in-vehicle relay device according to claim 6, wherein
the OSI reference model has the layer 1 to a layer 7.

8. The in-vehicle relay device according to claim 1, wherein
the layer 2 includes the layer 2 relay unit, and the layer 3 includes the layer 3 relay unit.

9. The in-vehicle relay device according to claim 1, wherein:
the layer 2 relay unit and the layer 3 relay unit performs communication between nodes.

10. An in-vehicle relay device comprising:
a hardware circuit;
a microcomputer, wherein
the hardware circuit performs functions of a layer 1 to a layer 3;
the microcomputer performs functions of a layer 4 and higher layers than the layer 4; and
the hardware circuit includes a layer 2 relay unit and a layer 3 relay unit.
